(19) United States
(12) Patent Application Publication
(10) Pub. No.: US 2022/0245401 A1
(43) Pub. Date: Aug. 4, 2022

(54) METHOD AND APPARATUS FOR TRAINING MODEL

(71) Applicant: BEIJING DAJIA INTERNET INFORMATION TECHNOLOGY CO., LTD., Beijing (CN)

(72) Inventors: Xiangru LIAN, Beijing (CN); Ji LIU, Beijing (CN)

(21) Appl. No.: 17/489,100

(22) Filed: Sep. 29, 2021

(30) Foreign Application Priority Data
Jan. 29, 2021 (CN) 202110130820.2

(51) Int. Cl. G06K 9/62; G06F 9/38

(52) U.S. Cl. CPC G06K 9/6257; G06F 9/3877; G06K 9/6288

(57) ABSTRACT

A method and an apparatus for training a model are provided. The method includes obtaining an initial model and a training sample set including a plurality of training samples generated based on multimedia data, performing a model training task and a model fusion task in parallel, repeating the action of performing the model training task and the model fusion task in parallel till a predetermined training termination condition is met.

### CROSS REFERENCE TO RELATED APPLICATIONS

The present application is based on and claim priority under 35 U.S.C. § 119 to Chinese Application No. 202110130820.2, filed with the China National Intellectual Property Administration on Jan. 29, 2021, the entire content of which is incorporated herein by reference.

### TECHNICAL FIELD

The disclosure relates to a field of computer technology, and more particularly to a method and an apparatus for training a model, an electronic device, a computer-readable storage medium, and a computer program product.

### BACKGROUND

With continuous development of neural networks and deep learning technologies, it tends to use a deep network model to process various data in industrial community.

In a process of training a deep network model, since the calculated amount and data amount of the model increase continuously, an actual efficiency requirement is hard to satisfy by a normal single-GPU training method, such that multi-GPU training methods, and multi-machine multi-GPU training methods become the most important accelerated means in actual trainings.

### SUMMARY

The disclosure provides a method and an apparatus for training a model, an electronic device, a computer-readable storage medium.

According to a first aspect of the disclosure, a method for training a model is provided. The method is applicable an electronic device and based on a training network including a plurality of training nodes. The method includes: obtaining an initial model and a training sample set, in which the training sample set includes a plurality of training samples generated based on multimedia data; performing a model training task and a model fusion task in parallel, in which the model fusion task includes: obtaining a local model of a first training node and a local model of a second training node, obtaining a fused model by fusing a local model of the first training node with the local model of the second training node, and replacing the local model of the first training node with the fused model; in which the model training task includes performing attribute prediction on multimedia data in a training sample based on the local model of the first training node, and updating the local model of the first training node based on a result of the attribute prediction; in which the local model of the first training node of the current model training task comprises one of the following: the initial model, a model obtained by a previous model training task of the current model training task and the fused model obtained by the model fusion task; and repeating the action of performing the model training task and the model fusion task in parallel, till a predetermined training termination condition is met.

According to a second aspect of the disclosure, an electronic device is provided. The electronic device includes a processor and a memory configured to store instructions executable by the processor. The processor is configured to execute the instructions to perform the method for training a model according to the first aspect.

According to a third aspect of the disclosure, a non-transitory computer readable storage medium is provided. When instructions in the computer readable storage medium are executed by a processor of an electronic device, the electronic device is caused to perform the method for training a model according to the first aspect.

It should be understood that the above general description and the following details are explanatory and illustrative, and shall not be construed to limit the present disclosure.

### BRIEF DESCRIPTION OF THE DRAWINGS

The accompanying drawings are incorporated into the disclosure as one part therein to illustrate embodiments of the disclosure. The accompanying drawings together with the specification explain the principle of the disclosure, but shall not be construed to limit the disclosure.

FIG. 1 is a flowchart illustrating a method for training a model according to an example embodiment.

FIG. 2 is a schematic diagram illustrating a structure of a training network in the related art.

FIG. 3 is a schematic diagram illustrating a structure of a training network according to an example embodiment.

FIG. 4 is a flowchart illustrating a method for training a model according to an example embodiment.

FIG. 5 is a flowchart illustrating a method for training a model according to an example embodiment.

FIG. 6 is a block diagram illustrating an apparatus for training a model according to an example embodiment.

FIG. 7 is a block diagram illustrating an electronic device according to an example embodiment.

FIG. 8 is a block diagram illustrating an electronic device according to an example embodiment.

### DETAILED DESCRIPTION

The solutions of the embodiments of the disclosure are clearly and completely described below with reference to the accompanying drawings in the embodiments of the disclosure.

It is to be understood those terms such as “first” and “second” in the specification, and claims and accompanying drawings may be used solely to distinguish similar objects without necessarily requiring or implying a specific order or sequence. It should be understood that such data may be exchangeable in an appropriate situation, so that embodiments described herein may be executed in an order other than that described in the accompanying or in the specification. The implementations described in the following embodiments shall not be construed to represent all implementations of the present disclosure. Rather, they are merely some examples of the apparatus and method according to some aspects of the present disclosure, as described in the claims.

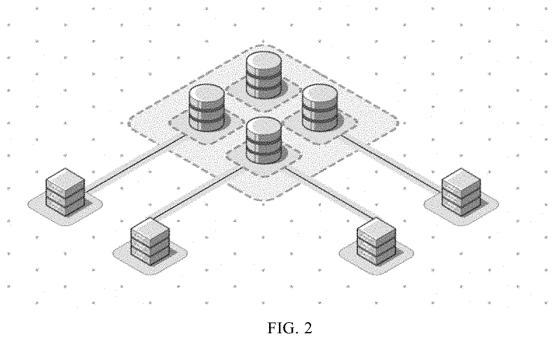

In the related art, a distributed training network typically includes a plurality of training machines, and FIG. 2 shows a topology of the distributed training network. The plurality of training machines may share a parameter server (as shown in the dotted box in FIG. 2). The parameter server is configured to store and update a model. During a training process, each training machine obtains the latest model from the parameter server, calculate a parameter gradient based on the model and return the parameter gradient to the parameter server asynchronously to update the model. In detail, in a synchronous training mode, the parameter server may update the model after receiving the parameter gradient returned by each training machine, and send the latest model to each training machine. In an asynchronous training mode, the parameter sever may update the model each time the parameter gradient returned from a training machine is received, and send the current model to the training machine upon receiving a request for the model from the training machine. Such distributed training network in the related art needs to configure resources for the parameter server, and the structure of the training network is complicated and costly, further a training speed is restricted to a bandwidth and a computing capability of the parameter server.

In a process of training a deep network model, since the calculated amount and data amount of the model increase continuously, an actual efficiency requirement is hard to satisfy by a normal single-GPU training method, such that multi-GPU training methods, and multi-machine multi-GPU training methods become the most important accelerated means in actual trainings. However, in a manufacture environment of a company or cloud, a training cluster typically is consisted of different types of machines. However, different machines may have different computing speeds and different parameters such as different network bandwidths, when a synchronized training method in the related art is used, it is required to wait for the slowest machine to complete training in each step of a training process, which causes a large waste of resources and slows the speed of training.

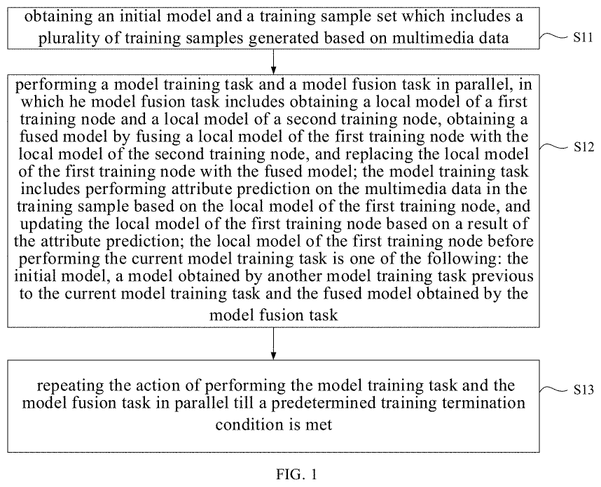

In order to solve the above problems, FIG. 1 shows a flowchart of a method for training a model according to an embodiment of the disclosure. An execution subject of the method may be an apparatus for training a model according to the embodiments of the disclosure, or an electronic device which may be implemented as hardware, software or, firmware or combinations thereof, such as a machine learning device or computer, which is not limited herein. As illustrated in FIG. 1, the method may be configured to training a deep learning model in the field of computer vision, nature language processing, or speech recognition and so on. The method may include the following.

At block S11, an initial model and a training sample set are obtained. The training sample set includes a plurality of training samples generated based on multimedia data.

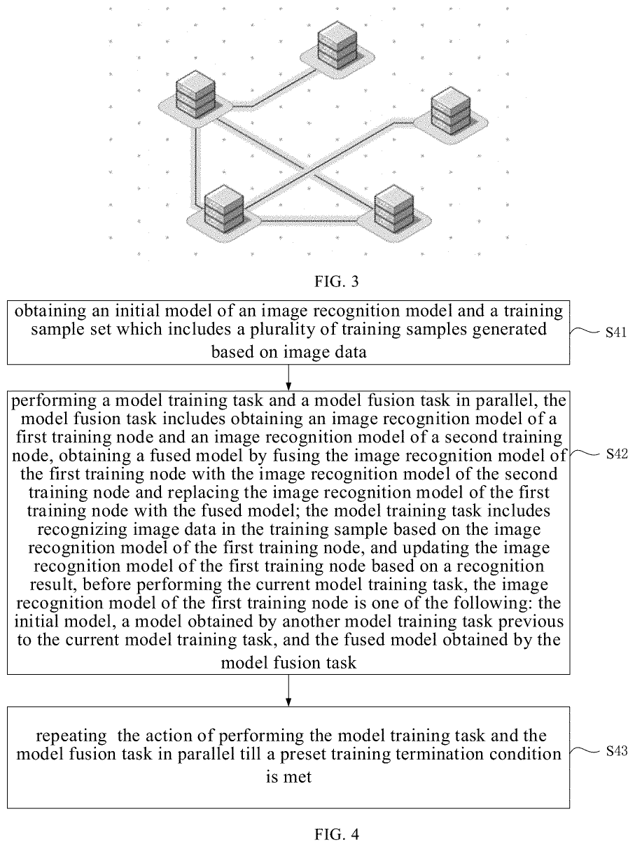

The method for training a model provided in the embodiment may be applied in a first training node in a training network. The training network may include a plurality of training nodes. The first training node is any one of the plurality of training nodes. The training nodes are connected via network to form a connected graph on the logic of communication, as illustrated in FIG. 3.

The training nodes may be located in different machine learning devices or computers, as illustrated in FIG. 3, which is not limited herein. In an actual application, each machine learning device or computer may include multiple training nodes.

Each training node may include one or more graphics processing units (GPUs), one or more central processing units (CPUs), one or more digital signal processors (DSPs) or other processors, which is not limited herein.

In some embodiments, each training node may include a graphics processing unit (GPU). The GPU has a high-effective capability for processing matrix multiplication and convolution. Therefore, in a case that one GPU is configured as one training node to perform the method for training model described in the embodiment, the model training may be completed effectively, and further the computing capability of each GPU may be fully utilized when compared to a solution that each training node includes multiple GPUs, thus avoiding waste of computing resources.

In the embodiment, a local model of the first training node is a deep learning model, which is configured to perform attribute prediction on the multimedia data. The attribute prediction may be configured to predict an attribute of the multimedia data. For example, when the attribute refers to a category of the multimedia data, the attribute prediction may be a category prediction; or when the attribute refers to a click-through rate, the attribute prediction may be a click-through rate prediction; or when the multimedia data is an image and the attribute refers to an image attribute, the attribute prediction may be a prediction of an image splitting result or an image recognition result.

In some embodiments, a plurality of training nodes may perform cooperative training to obtain the above-mentioned deep learning model. The plurality of training nodes may complete the training of the deep learning model in parallel.

Before the first training, an initial model of the deep learning model (i.e., initialized deep learning model) is stored in each training node as the local model of each training node. The initial model is taken as a base to perform many times of training and updating of the local model. In an embodiment, the initial model in each training node may be the same, which is not limited herein. An effect of unbalanced computing capabilities of training nodes may be reduced by configuring the same initial model in the training nodes.

Further, the training sample set may be stored on each training node. The training sample sets stored on the training nodes may be the same or different, which is not limited herein. When the training sample sets are different, repeated trainings on the same training sample performed by different training nodes may be avoided, such that all the computing resources may be fully utilized to improve a fusion efficiency, thus realizing a high-effective distributed training.

The training sample set may include a plurality of training samples generated based on the multimedia data. The multimedia data may include at least one of video data, image data, audio data and text data.

At block S12, a model training task and a model fusion task are performed in parallel. The model fusion task includes obtaining a local model of a first training node and a local model of a second training node, obtaining a fused model by fusing the local model of the first training node with the local model of the second training node and replacing the local model of the first training node with the fused model. The model training task includes performing attribute prediction on the multimedia data in the training sample based on the local model of the first training node, and updating the local model of the first training node based on a result of the attribute prediction. Before performing the current model training task, the local model of the first training node is one of the following: the initial model, a model obtained by a previous model training task of the current model training task, and the fused model obtained by the model fusion task.

The second training node may be any one training node other than the first training node from the plurality of the training nodes. The first training node and the second training node may be located in the same machine learning device or computer, or in different machine learning devices or computers, which is not limited herein.

The local model of the first training node may be updated continuously in a process of performing the model training task. In the process of performing the model training task, the multimedia data in the training sample may be inputted into the local model of the first training node, the attribute prediction may be performed on the multimedia data by the local model of the first training node, an output of the local model of the first training node is taken as the result of the attribute prediction, and the result is used to update the local model of the first training node. The model training task will be described in detail in the following embodiments.

In the model fusion task, the first training node may randomly select the second training node, obtain the local model of the second training node, fuse the local model of the first training node with the local model of the second training node to obtain the fused model, and update the local model of the first training node with the fused model. The model fusion task is performed asynchronously and independently to the model training node. The model fusion task will be described in detail in the following embodiments.

Before the first model training task is performed, the local model of the first training node is the initial model. During the training process, before the Nth model training task is performed, if the local model of the first training node is replaced with the fused model, then the local model of the first training node before performing the Nth training is the fused model; if the local model of the first training node is not replaced with the fused model, then the local model of the first training node before performing the Nth training is the model obtained by the previous training, i.e. the (N−1)th model training task.

In the embodiment, each training node may perform the model training task and the model fusion task in parallel continuously, and the model fusion between training nodes may be realized with no waiting. Each training node may perform the model training task at top speed. Even when the training machines of training nodes have different configurations, the computing capability of each machine may be fully utilized to improve the speed of training the model.

At block S13, the action of performing the model training task and the model fusion task in parallel is repeated till a predetermined training termination condition is met.

In the embodiment, it is determined whether the local model of the first training node meets a training termination condition, it yes, the model training task and the model fusion task are stopped, or else, the action of performing the model training task and the model fusion task in parallel is repeated till the training termination condition is met.

In some embodiments, the training termination condition may include a precision of the local model of the first training node reaching a preset precision, or a number of trainings performed on the local model of the first training node reaching a preset number. The number of trainings performed on the local model of the first training node refers to the number of times of performing the model training task. The local mode of each training node may converge to a same accuracy by setting the training termination condition.

In some embodiments, it may be determined whether the local model of the first training node meets the training termination condition after each training is completed or in a preset time interval, if not, looping execution of actions at blocks S12-S13 proceeds, and if yes, the training is ended.

In an actual application, the local model of the first training node meeting the training termination condition, i.e., the deep learning model obtained by completing the training may perform the attribute prediction on the multimedia data, for example performing the image recognition prediction or image splitting prediction on the image data in the multimedia data, or performing the speech recognition prediction on the speech data in the multimedia data, or performing the click-through rate prediction on the multimedia data.

With the asynchronous distributed model training method provided in the embodiment, since the model training task and the model fusion task are performed in parallel, each training node may continually train and update its local model, meanwhile, each training node may fuse its local model with a local model of another training node, such that each training node may realize the model training at top speed, and further the model fusion between training nodes may be realized with no waiting, thereby improving a speed of training the model. Further, it is unnecessary to set a parameter node in the technical solution, and each training node may be implemented as a training machine of any configuration to realize the distributed training, such that the structure for training is simple, and further resources may be saved. The training speed is no longer restricted to the bandwidth and the computing capability of the parameter node, all the computing resources may be utilized fully to implement the high-effective distributed training. With the technical solution provided in the embodiment, a linear acceleration may be realized in most training scenarios, i.e., enhancement of speed of training the model may be in direct proportion to increment of the computing capability of the training machine.

In some embodiments, the model fusion task at block S12 may further includes causing the second training node to fuse the local model of the first training node with the local model of the second training node and to replace the local model of the second training node with the fused model by sending the local model of the first training node to the second training node.

In the model fusion task, the first training node may send the local model of the first training node to the second training node at the same time when the local model of the second training node is obtained, and the second training node may fuse the local model of the second training node with the local model of the first training node to obtain the fused node and replace the local model of the second training node with the fused model. In an embodiment, the second training node may further train the fused model based on the training sample set stored locally and update the local model of the second training node.

In the embodiment, since the sending bandwidth and the receiving bandwidth of network are independent, a process that the first training node sends the local model of the first training node to the second training node and a process that the first training node receives the local model of the second training node may proceed in parallel, such that an efficiency of training the model may be further improved.

In the model fusion task, after the first training node fuses the local model of the first training node with the local model of the second training node, the first training node may update the local model of the first training node with the fused model, meanwhile, the fused model is sent to the second training node, so as to cause the second training node to update the local model of the second training node based on the fused model.

In an embodiment, the action of obtaining the fused model by fusing the local model of the first training node with the local model of the second training node at block S12 may include obtaining a weighted average of a parameter of the local model of the first training node and a parameter of the local model of the second training node, and obtaining the fused model by determining the weighted average as a parameter of the fused model. A weight coefficient of each training node may be set according to actual needs, which is not limited herein.

For example, an average of the parameter of the local model of the first training node and the parameter of the local model of the second training node may be calculated, and the average is determined as the parameter of the fused model to obtain the fused model.

In the embodiment, by performing weighted averaging on the parameters of local models of different training nodes, an effect of unbalanced computing capabilities on the training result may be eliminated, so as to ensure that the local model of each training node may converge to the same model with high accuracy.

In an embodiment, the action of performing the model training task and the model fusion task in parallel at block S12 may include creating a first operation queue and a second operation queue, in which the first operation queue and the second operation queue are processed in parallel; and performing the model training task in the first operation queue and the model fusion task in the second operation queue.

Operations in each operation queue may be performed in a specified order. Each operation queue may be considered to be a task, and these tasks may be performed in parallel. For example the operation queue may be a compute unified device architecture (CUDA) stream. The CUDA stream relates to a concept of concurrence, including a group of operations performed in sequence. Multiple CUDA streams relate to a concept of parallelism, and multiple CUDA streams may be used to perform data duplication and core function calculation in parallel. In the first training node, two parallel-processed CUDA streams may be created to respectively perform the model training task and the model fusion task.

In the embodiment, two operation queues are used to realize the parallel execution of the model training task and the model fusion task, such that the calculation performance may be improved, thus further improving the speed of training the model.

In some embodiments, at block S12, the model fusion task may be performed in a preset time interval. The preset time interval is greater than or equal to a time period during which a single training is performed on the local model of the first training node.

In some embodiments, the preset time interval of performing the model fusion task may be set according to actual needs, which is not limited herein. When the preset time interval is greater than or equal to the time period during which a single training is performed on the local model of the first training node, data transmission between the training nodes may be reduced and network overhead may be saved compared to a solution of performing the model fusion task incessantly.

In some embodiments, the training sample set further includes label data corresponding to the multimedia data in the training sample. The model training task at block S12 may include obtaining output data of the attribute prediction performed on the multimedia data in the training sample based on the local model of the first training node; determining a parameter gradient of the local model of the first training node based on the output data and the label data; and updating the local model of the first training node based on the parameter gradient.

Each training sample in the training sample set may include multimedia data and label data corresponding to the multimedia data.

The label data may be configured to distinguish a positive training sample and a negative training sample. For example when the label data is 1, the corresponding multimedia data is considered as a positive training sample, and when the label data is 0, the corresponding multimedia data is considered as a negative training sample.

In the model training task, the first training node may randomly select the training sample from the training sample set. The local model of the first training node may perform attribute prediction on the multimedia data in the training sample and the result of the attribute prediction is output data of the local model of the first training node. A loss value of the training sample is calculated based on the output data and the label data in the training sample. A back propagation algorithm is used to perform back propagation on the loss value to determine the parameter gradient. The parameter of the local model of the first training node is adjusted based on the parameter gradient to realize update of the local model of the first training node. The parameter gradient is used to represent an adjustment amount of the parameter of the local model of the first training node. The process of training the model may be performed locally at each training node.

FIG. 4 is a flowchart illustrating a method for training a model according to an example embodiment. As illustrated in FIG. 4, the method is applied in a process of training an image recognition model. The method may include the following.

At block S41, an initial model of an image recognition model and a training sample set are obtained. The training sample set includes a plurality of training samples generated based on image data.

At block S42, a model training task and a model fusion task are performed in parallel. The model fusion task includes obtaining an image recognition model of a second training node and an image recognition model of a second training node, obtaining a fused model by fusing the image recognition model of the first training node with the image recognition model of the second training node and replacing the image recognition model of the first training node with the fused model. The model training task includes recognizing image data in the training sample based on the image recognition model of the first training node, and updating the image recognition model of the first training node based on a recognition result. Before performing the current model training task, the image recognition model of the first training node is one of the following: the initial model, a model obtained by a previous model training task of the current model training task, and the fused model obtained by the model fusion task.

At block S43, the action of performing the model training task and the model fusion task in parallel is repeated till a preset training termination condition is met.

Before the first training performed on the image recognition model, the first training node obtains the initial model of the image recognition model and the training sample set. The initial model of the image recognition model is an initialized image recognition model. Each training sample in the training sample set may include image data and label data corresponding to the image data.

The model training task and the model fusion task of the image recognition model are performed in parallel. In the model training task, feature extraction is performed on the image data in the training sample based on a network structure of the image recognition model of the first training node, splicing processing is performed on the extracted image features, full-connecting processing is performed on the splicing-processed features, an image recognition result is obtained based on a result of the full-connecting processing, a loss value corresponding to the training sample is determined based on the image recognition result and the label data in the training sample, a back propagation algorithm is used to perform back propagation on the loss value to determine a parameter gradient of the image recognition model, and a parameter of the image recognition model of the first training node is adjusted based on the parameter gradient to realize update of the image recognition model of the first training node. In the model fusion task, the first training node may randomly select the second training node incessantly, obtain the image recognition model of the second training node, fuse the image recognition model of the first training node with the image recognition model of the second training node to obtain the fused model and update the image recognition model of the first training node with the fused model. The model fusion task is independent to the model training task and performed asynchronously and incessantly.

Regarding specific implementations of the above blocks, reference can be made to the foregoing embodiments, which is not elaborated here.

After the training of the image recognition model is completed, the image data may be recognized. The image recognition model performs feature extraction on the image data, performs splicing processing on the extracted image features, performs full-connecting processing on the splicing-processed features and obtains the image recognition result based on a result of the full-connecting processing.

Since the model training task and the model fusion task are performed in parallel when the image recognition model is trained, each training node may continually train and update its image recognition model, meanwhile, each training node may fuse its image recognition model with an image recognition model of another training node, such that each training node may realize training of the image recognition model at top speed, and further fusion of the image recognition models between training nodes may be realized with no waiting, thereby improving a speed of training the model. Further, it is unnecessary to set a parameter node in the technical solution, and each training node may be implemented as a training machine of any configuration to realize distributed training of the image recognition model, such that the structure for training is simple, and further resources may be saved. The training speed is no longer restricted to the bandwidth and the computing capability of the parameter node, all the computing resources may be fully utilized to implement the high-effective distributed training.

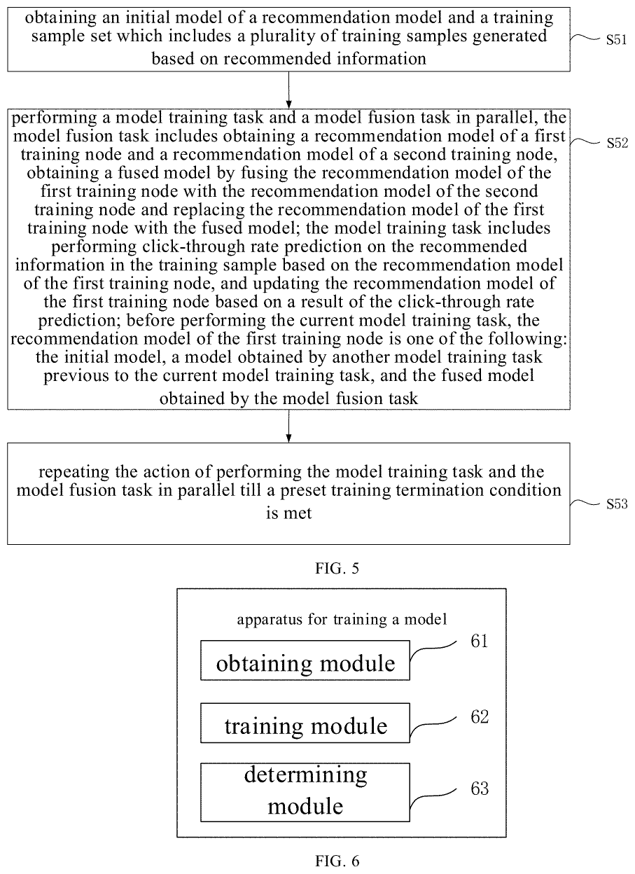

FIG. 5 is a flowchart illustrating a method for training a model according to an example embodiment. As illustrated in FIG. 5, the method is applied in a process of training a recommendation model. The method may include the following.

At block S51, an initial model of a recommendation model and a training sample set are obtained. The training sample set includes a plurality of training samples generated based on recommended information.

In an embodiment, each training sample in the training sample set may include current recommended information, historical behaviors information and label data. The label data may indicate whether a user clicks the current recommended information. If yes, the label data is 1, if no, the label data is 0. The recommended information is multimedia data, such as at least one of video data, image data, audio data and text data.

At block S52, a model training task and a model fusion task are performed in parallel. The model fusion task includes obtaining a recommendation model of a second training node and a recommendation model of a second training node, obtaining a fused model by fusing the recommendation model of the first training node with the recommendation model of the second training node and replacing the recommendation model of the first training node with the fused model. The model training task includes performing click-through rate prediction on the recommended information in the training sample based on the recommendation model of the first training node, and updating the recommendation model of the first training node based on a result of the click-through rate prediction. Before performing the current model training task, the recommendation model of the first training node is one of the following: the initial model, a model obtained by a previous model training task of the current model training task, and the fused model obtained by the model fusion task.

At block S53, the action of performing the model training task and the model fusion task in parallel is repeated till a preset training termination condition is met.

Before the first training performed on the recommendation model, the first training node obtains the initial model of the recommendation model and the training sample set. The initial model of the recommendation model is an initialized recommendation model.

The model training task and the model fusion task of the image recognition model are performed in parallel. In the model training task, the historical behaviors information in the training sample is analyzed to determine a preference feature of the user and a similarity between the preference feature and the current recommended information is determined based on a network structure of the recommendation model of the first training node, the similarity is determined as a result of click-through rate prediction of the recommendation model, a loss value corresponding to the training sample is determined based on the result of click-through rate prediction and the label data in the training sample, a back propagation algorithm is used to perform back propagation on the loss value to determine a parameter gradient of the recommendation model, and a parameter of the recommendation model of the first training node is adjusted based on the parameter gradient to realize update of the recommendation model of the first training node. In the model fusion task, the first training node may randomly select the second training node incessantly, obtain the recommendation model of the second training node, fuse the recommendation model of the first training node with the recommendation model of the second training node to obtain the fused model and update the recommendation model of the first training node with the fused model. The model fusion task is independent to the model training task and performed asynchronously and incessantly.

After the training of the recommendation model is completed, the click-through rate prediction may be performed on the multimedia data. The multimedia data may be for example at least one of video data, image data, audio data and text data.

Regarding specific implementations of the above blocks, reference can be made to the foregoing embodiments, which is not elaborated here.

Since the model training task and the model fusion task are performed in parallel when the recommendation model is trained, each training node may continually train and update its recommendation model, meanwhile, each training node may fuse its recommendation model with a recommendation model of another training node, such that each training node may realize training of the recommendation model at top speed, and further fusion of the recommendation models between training nodes may be realized with no waiting, thereby improving a speed of training the model. Further, it is unnecessary to set a parameter node in the technical solution, and each training node may be implemented as a training machine of any configuration to realize distributed training of the image recognition model, such that the structure for training is simple, and further resources may be saved. The training speed is no longer restricted to the bandwidth and the computing capability of the parameter node, all the computing resources may be fully utilized to implement the high-effective distributed training.

FIG. 6 is a block diagram illustrating an apparatus for training a model according to an example embodiment. The apparatus is based on a training network including a plurality of training nodes. As illustrated in FIG. 6, the apparatus may include an obtaining module 61, a training module 62 and a determining module 63.

The obtaining module 61 is configured to obtain an initial model and a training sample set, in which the training sample set comprises a plurality of training samples generated based on multimedia data.

The training module 62 is configured to perform a model training task and a model fusion task in parallel. The model fusion task includes obtaining a local model of a first training node and a local model of a second training node, obtaining a fused model by fusing a local model of the first training node with the local model of the second training node, and replacing the local model of the first training node with the fused model. The model training task includes performing attribute prediction on the multimedia data in the training sample based on the local model of the first training node, and updating the local model of the first training node based on a result of the attribute prediction. The local model of the first training node before performing the model training task is one of the following: the initial model, a model obtained by a previous model training task of the model training task and the fused model obtained by the model fusion task.

The determining module 63 is configured to repeatedly call the training module to perform the model training task and the model fusion task in parallel, till a predetermined training termination condition is met.

In some embodiments, the training module is configured to replace the local model of the second training node with the fused model.

In some embodiments, the training module is configured to obtain a weighted average of a parameter of the local model of the first training node and a parameter of the local model of the second training node, and obtain the fused model by determining the weighted average as a parameter of the fused model.

In some embodiments, the training module is configured to perform the model fusion task in a preset time interval, in which the preset time interval is greater than or equal to a time period during which a single training is performed on the local model of the first training node.

In some embodiments, the training sample set further includes label data corresponding to the multimedia data in the training sample. The training module is configured to obtain output data of the attribute prediction performed on the multimedia data in the training sample based on the local model of the first training node, determine a parameter gradient of the local model of the first training node based on the output data and the label data and update the local model of the first training node based on the parameter gradient.

In some embodiments, the training module is configured to create a first operation queue and a second operation queue, in which the first operation queue and the second operation queue are processed in parallel; and perform the model training task in the first operation queue and the model fusion task in the second operation queue.

In some embodiments, different training nodes have different training sample sets.

In some embodiments, all training nodes have the same initial model.

In some embodiments, the training termination condition includes a precision of the local model of the first training node reaching a preset precision; or a number of trainings performed on the local model of the first training node reaching a preset number.

With respect to the apparatus according to the embodiment described above, the ways to perform operations by respective modules have been described in the associated method embodiments, which are not described here.

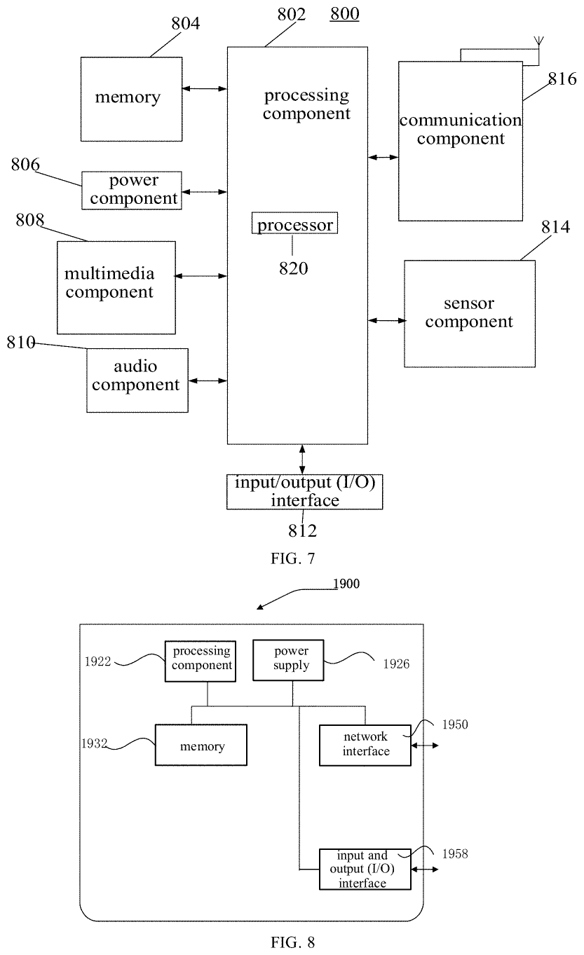

FIG. 7 is a block diagram of an electronic device 800 according to an example embodiment. For example, the electronic device 800 may be a mobile phone, a computer, a digital broadcasting terminal, a messaging device, a game console, a tablet device, a medical device, a fitness device, a personal digital assistant, etc.

As illustrated in FIG. 7, the electronic device 800 may include one or more components: a processing component 802, a memory 804, a power component 806, a multimedia component 808, an audio component 810, an input/output (I/O) interface 812, a sensor component 814, and a communication component 816.

The processing component 802 generally controls the overall operations of the electronic device 800, such as operations associated with display, telephone calls, data communications, camera operations, and recording operations. The processing component 802 may include one or more processors 820 to execute instructions to complete all or part of the steps of the foregoing method. In addition, the processing component 802 may include one or more modules to facilitate the interaction between the processing component 802 and other components. For example, the processing component 802 may include a multimedia module to facilitate the interaction between the multimedia component 808 and the processing component 802.

The memory 804 is configured to store various types of data to support operations in the electronic device 800. Examples of these data include instructions for any application or method operating on the electronic device 800, contact data, phone book data, messages, pictures, videos, and so on. The memory 804 can be implemented by any type of volatile or non-volatile storage device or their combination, such as static random access memory (SRAM), electrically erasable programmable read-only memory (EEPROM), erasable and programmable read-only memory (EPROM), programmable read-only memory (PROM), read-only memory (ROM), magnetic memory, flash memory, magnetic disk or optical disk.

The power component 806 provides power to various components of the electronic device 800. The power component 806 may include a power management system, one or more power supplies, and other components associated with generating, managing, and distributing power for the electronic device 800.

The multimedia component 808 includes a screen that provides an output interface between the electronic device 800 and the user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touch, sliding, and gestures on the touch panel. The touch sensor can not only sense the boundary of the touch or slide action, but also detect the duration and pressure related to the touch or slide operation. In some embodiments, the multimedia component 808 includes a front camera and/or a rear camera. When the electronic device 800 is in an operation mode, such as a shooting mode or a video mode, the front camera and/or the rear camera can receive external multimedia data. Each front camera and rear camera can be a fixed optical lens system or an optical lens system having focal length and optical zoom capabilities.

The audio component 810 is configured to output and/or input audio signals. For example, the audio component 810 includes a microphone (MIC). When the electronic device 800 is in an operating mode, such as a call mode, a recording mode, and a voice recognition mode, the microphone is configured to receive external audio signals. The received audio signals may be further stored in the memory 804 or transmitted via the communication component 816. In some embodiments, the audio component 810 further includes a speaker for outputting audio signals.

The I/O interface 812 provides an interface between the processing component 802 and a peripheral interface module. The above-mentioned peripheral interface module may be a keyboard, a click wheel, a button, and the like. These buttons may include but are not limited to: home button, volume button, start button, and lock button.

The sensor component 814 includes one or more sensors for providing the electronic device 800 with various aspects of state assessment. For example, the sensor component 814 can detect the open/close state of the electronic device 800 and the relative positioning of components, such as the display and keypad of the electronic device 800. The sensor component 814 can also detect the position change of the electronic device 800 or a component of the electronic device 800, presence or absence of contact of the user to the electronic device 800, the orientation or acceleration/deceleration of the electronic device 800, and the temperature change of the electronic device 800. The sensor component 814 may include a proximity sensor configured to detect the presence of nearby objects when there is no physical contact. The sensor component 814 may also include a light sensor, such as a CMOS or CCD image sensor, for use in imaging applications. In some embodiments, the sensor component 814 may also include an acceleration sensor, a gyroscope sensor, a magnetic sensor, a pressure sensor or a temperature sensor.

The communication component 816 is configured to facilitate wired or wireless communication between the electronic device 800 and other devices. The electronic device 800 can access a wireless network based on a communication standard, such as Wi-Fi, 2G, or 3G, or a combination thereof. In an exemplary embodiment, the communication component 816 receives a broadcast signal or broadcast related information from an external broadcast management system via a broadcast channel. In an exemplary embodiment, the communication component 816 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In an exemplary embodiment, the electronic device 800 may be implemented by one or more application specific integrated circuits (ASICs), digital signal processors (DSP), digital signal processing devices (DSPD), programmable logic devices (PLD), field programmable gate array (FPGA), controller, microcontroller, microprocessor, or other electronic components, used to perform the above methods.

Another exemplary embodiment of the present disclosure provides a non-transitory computer-readable storage medium, such as memory 804 including instructions, which can be executed by the processor 820 of the electronic device 800 to complete the foregoing method. For example, the computer-readable storage medium may be ROM, random access memory (RAM), CD-ROM, magnetic tape, floppy disk, optical data storage device, etc.

Another exemplary embodiment of the present disclosure provides a computer program product including readable program codes, which can be executed by the processor 820 of the electronic device 800 to complete the foregoing method. Alternatively, the program codes may be stored in a computer-readable storage medium of the electronic device 800, which may be ROM, random access memory (RAM), CD-ROM, magnetic tape, floppy disk, optical data storage device, etc.

FIG. 8 is a block diagram of an electronic device 1900 according to an example embodiment of the disclosure. The electronic device 1900 may be implemented as a server.

Referring to FIG. 8, the electronic device 1900 may include a processing component 1922 including one or more processors, and a memory resource represented by a memory 1932 for storing instructions (such as application programs) executable by the processing component 1922. The application programs stored in the memory 1932 may include one or more modules, and each module may correspond to a series of instructions. Furthermore, the processing component 1922 may be configured to execute the instructions so as to perform the above-mentioned method for training a model.

The electronic device 1900 may further include a power supply 1926 configured to perform a power management of the electronic device 1900, a wired or wireless network interface 1950 configured to connect the electronic device 1900 to the internet, and an input and output (I/O) interface 1958. The electronic device 1900 may operate an operating system stored in the memory 1932, such as Windows Server™, Mac OS X™, Unix™, Linux™, FreeBSD™ and so on.

Those skilled in the art may easily conceive of other embodiments of the disclosure by considering the description and practicing the disclosure disclosed herein. This disclosure is intended to cover any variations, uses, or adaptive changes that follow the general principles of this disclosure and include common general knowledge or customary technical means in the technical field not disclosed in this disclosure. The description and examples are to be considered exemplary only, and the true scope and spirit of this disclosure are disclosed by the claims.

It should be understood that the disclosure is not limited to the precise structure that has been described above and shown in the drawings, and various modifications and changes can be made without departing from the scope thereof. The scope of the disclosure is limited only by the appended claims.

1. A method for training a model, applicable in an electronic device and based on a training network comprising a plurality of training nodes, the method comprises:
obtaining an initial model and a training sample set, wherein the training sample set comprises a plurality of training samples generated based on multimedia data;
performing a model training task and a model fusion task in parallel,
wherein the model fusion task comprises: obtaining a local model of a first training node and a local model of a second training node, obtaining a fused model by fusing a local model of the first training node with the local model of the second training node, and replacing the local model of the first training node with the fused model;
wherein the model training task comprises: performing attribute prediction on multimedia data in a training sample based on the local model of the first training node, and updating the local model of the first training node based on a result of the attribute prediction, wherein the local model of the first training node of the current model training task comprises one of the following: the initial model, a model obtained by a previous model training task of the current model training task and the fused model obtained by the model fusion task;
repeating the action of performing the model training task and the model fusion task in parallel till a predetermined training termination condition is met.

2. The method of claim 1, wherein the model fusion task further comprises:
replacing the local model of the second training node with the fused model.

3. The method of claim 1, said obtaining a fused model by fusing a local model of the first training node with the local model of the second training node comprising:
obtaining a weighted average of a parameter of the local model of the first training node and a parameter of the local model of the second training node; and
obtaining the fused model by determining the weighted average as a parameter of the fused model.

4. The method of claim 1, said performing the model fusion task comprising:
performing the model fusion task in a preset time interval, wherein the preset time interval is greater than or equal to a time period during which a single training is performed on the local model of the first training node, wherein the single training at most comprises performing the model training task and the model fusion task once.

5. The method of claim 1, wherein the training sample set further comprises label data corresponding to the multimedia data in the training sample, and the model training task comprises:
obtaining output data of the attribute prediction performed on the multimedia data in the training sample based on the local model of the first training node;
determining a parameter gradient of the local model of the first training node based on the output data and the label data; and
updating the local model of the first training node based on the parameter gradient.

6. The method of claim 1, said performing a model training task and a model fusion task in parallel comprising:
creating a first operation queue and a second operation queue, wherein the first operation queue and the second operation queue are processed in parallel; and
performing the model training task in the first operation queue and the model fusion task in the second operation queue.

7. The method of claim 1, wherein different training nodes have different training sample sets.

8. The method of claim 1, wherein all training nodes have the same initial model.

9. The method of claim 1, wherein the training termination condition comprises at least one of the following:
a precision of the local model of the first training node reaching a preset precision; and
a number of trainings performed on the local model of the first training node reaching a preset number.

10. An apparatus for training a model, based on a training network comprising a plurality of training nodes, the apparatus comprises:
a processor; and
a memory configured to store instructions executable by the processor;
wherein the processor is configured to execute the instructions to perform the method for training a model, comprising:
obtaining an initial model and a training sample set, wherein the training sample set comprises a plurality of training samples generated based on multimedia data;
performing a model training task and a model fusion task in parallel,
wherein the model fusion task comprises: obtaining a local model of a first training node and a local model of a second training node, obtaining a fused model by fusing a local model of the first training node with the local model of the second training node, and replacing the local model of the first training node with the fused model;
wherein the model training task comprises: performing attribute prediction on multimedia data in a training sample based on the local model of the first training node, and updating the local model of the first training node based on a result of the attribute prediction; wherein the local model of the first training node of the current model training task comprises one of the following: the initial model, a model obtained by a previous model training task of the current model training task and the fused model obtained by the model fusion task;
and
repeating the action of performing the model training task and the model fusion task in parallel, till a predetermined training termination condition is met.

11. The apparatus of claim 10, wherein the model fusion task further comprises:
replacing the local model of the second training node with the fused model.

12. The apparatus of claim 10, said obtaining a fused model by fusing a local model of the first training node with the local model of the second training node comprising:
obtaining a weighted average of a parameter of the local model of the first training node and a parameter of the local model of the second training node; and
obtaining the fused model by determining the weighted average as a parameter of the fused model.

13. The apparatus of claim 10, said performing the model fusion task comprising:
performing the model fusion task in a preset time interval, wherein the preset time interval is greater than or equal to a time period during which a single training is performed on the local model of the first training node, wherein the single training at most comprises performing the model training task and the model fusion task once.

14. The apparatus of claim 10, wherein the training sample set further comprises label data corresponding to the multimedia data in the training sample, and the model training task comprises:
obtaining output data of the attribute prediction performed on the multimedia data in the training sample based on the local model of the first training node;
determining a parameter gradient of the local model of the first training node based on the output data and the label data; and
updating the local model of the first training node based on the parameter gradient.

15. The apparatus of claim 10, said performing a model training task and a model fusion task in parallel comprising:
creating a first operation queue and a second operation queue, wherein the first operation queue and the second operation queue are processed in parallel; and
performing the model training task in the first operation queue and the model fusion task in the second operation queue.

16. The apparatus of claim 10, wherein different training nodes have different training sample sets.

17. The apparatus of claim 10, wherein all training nodes have the same initial model.

18. The apparatus of claim 10, wherein the training termination condition comprises at least one of the following:
a precision of the local model of the first training node reaching a preset precision; and
a number of trainings performed on the local model of the first training node reaching a preset number.

19. A non-transitory computer readable storage medium, wherein when instructions in the computer readable storage medium are executed by a processor of an electronic device, the electronic device is caused to perform a method for training a model, based on a training network comprising a plurality of training nodes, the method comprises:
obtaining an initial model and a training sample set, wherein the training sample set comprises a plurality of training samples generated based on multimedia data;
performing a model training task and a model fusion task in parallel,
wherein the model fusion task comprises: obtaining a local model of a first training node and a local model of a second training node, obtaining a fused model by fusing a local model of the first training node with the local model of the second training node, and replacing the local model of the first training node with the fused model;
wherein the model training task comprises: performing attribute prediction on multimedia data in a training sample based on the local model of the first training node, and updating the local model of the first training node based on a result of the attribute prediction; wherein the local model of the first training node of the current model training task comprises one of the following: the initial model, a model obtained by a previous model training task of the current model training task and the fused model obtained by the model fusion task;
and
repeating the action of performing the model training task and the model fusion task in parallel, till a predetermined training termination condition is met.

20. The storage medium of claim 19, wherein the model fusion task further comprises:
replacing the local model of the second training node with the fused model.
